(19) United States
(12) Patent Application Publication
(10) Pub. No.: US 2002/0124745 A1
(43) Pub. Date: Sep. 12, 2002

(54) Printing unit drive

(76) Inventor: Jean-Claude Pautrat, Paris (FR)

Correspondence Address: LERNER AND GREENBERG, P.A., Post Office Box 2480, Hollywood, FL, 33022-2480, US

(21) Appl. No.: 10/096,232

(22) Filed: Mar. 12, 2002

(30) Foreign Application Priority Data
Mar. 12, 2001 (DE) 101 11 650.0

(51) Int. Cl. B41F 7/02

(52) U.S. Cl. 101/217

(57) ABSTRACT

In a first printing unit having a first printing form cylinder and a first transfer cylinder, there is provided a printing unit drive including a first drive motor for separately driving the first printing form cylinder, and a line shaft drive motor for jointly driving the first transfer cylinder and a second transfer cylinder of a second printing unit; a printing machine having the printing unit and/or the printing unit drive.

### BACKGROUND OF THE INVENTION

### Field of the Invention

The invention relates to a printing unit drive, in particular, for printing units in a web-fed rotary printing machine, and to a printing unit having such a drive.

In a printing machine, for example in a web-fed rotary offset printing machine, a transported paper web is guided through a large number of rubber/rubber printing units, which print an image, for example a multicolor image, on one or both sides of the web. For the drive of the printing units, various types of drive systems and drive principles have become known heretofore from the prior art.

For example, the published German Patent Document DE 198 52 438 A1 discloses a printing unit for a web-fed rotary printing machine, which comprises a first printing form cylinder, a first blanket cylinder assigned to the first printing form cylinder, a second printing form cylinder and a second blanket cylinder assigned to the second printing form cylinder, the second blanket cylinder being in rolling contact with the first blanket cylinder and coupled mechanically therewith. Also provided are a first drive motor for an individual drive of the first printing form cylinder, a second drive motor for the individual drive of the second printing form cylinder, and a third drive motor for a common drive of the first and the second blanket cylinder. This drive principle makes possible the prevention of printing faults, in particular register faults between a first pair of press cylinders (first printing form cylinder and first blanket cylinder) and a second pair of press cylinders (second printing form cylinder and second blanket cylinder), because the two blanket cylinders engaged with one another are rotated without slip by the common drive of the third drive motor and the result of being driven jointly by the third drive motor, and both printing form cylinders can be set in register independently, i.e., individually. Furthermore, this drive principle permits the use of the printing unit either as a conventional rubber/rubber printing unit or as an imprinting unit, wherein one or both printing form cylinders are set off from the appertaining blanket cylinder and provided with a new printing form during the production or continuous printing operation of the printing machine. Three motors are therefore necessary for each printing unit, the three motors being controlled by control and regulation electronics for the in-register printing or the imprinting-unit functionality (imprinter).

Furthermore, the published German Patent Document DE 41 27 321 discloses a drive for a web-fed rotary printing machine, each printing unit cylinder in a printing unit having directly assigned thereto its own drive motor which, via a respective force pick-off unit, is couplable with a horizontal and/or vertical shaft for synchronizing the printing units which are arranged in-line and/or in a stacked or multilevel configuration. The synchronization of the individual printing units is therewith implemented by a mechanical line shaft, the individual printing units being couplable in-register via pneumatic or electromagnetic one-to-one couplings. It is a drawback of this drive that, in the case of printing machines having many printing units, a corresponding number of costly coupling devices have to be provided and an automatic control and/or regulating system has to be provided in order to control the register-maintaining coupling operation. Furthermore, a printing unit according to the aforementioned published German patent Document DE 41 27 321 A1 does not have any imprinting-unit functionality, because it is not possible to set off individual printing form cylinders from the assigned blanket cylinder during the continuous or production printing operation of the printing machine and to provide them with a new printing form.

### SUMMARY OF THE INVENTION

Taking the prior art into consideration, it is an object of the invention to provide a printing unit drive which, when using a low number of drive motors and control and/or regulating electronics of limited complexity, permits in-register printing of the printing material. A further object of the invention is to provide a printing unit drive which, when using a low number of drive motors and control and/or regulating electronics of limited complexity, permits the driven drive unit to be operated as an imprinting unit.

With the foregoing and other objects in view, there is provided, in accordance with one aspect of the invention, in a first printing unit having a first printing form cylinder and a first transfer cylinder, a printing unit drive comprising a first drive motor for separately driving the first printing form cylinder, and a line shaft drive motor for jointly driving the first transfer cylinder and a second transfer cylinder of a second printing unit.

In accordance with another feature of the invention, the second printing unit has a second printing form cylinder, and the drive further comprises a second drive motor for separately driving the second printing form cylinder.

In accordance with a further feature of the invention, the line shaft drive motor serves for driving at least one of a first impression cylinder of the first printing unit and a second impression cylinder of the second printing unit.

In accordance with an added feature of the invention, the first printing unit further has a third printing form cylinder and a third transfer cylinder, and the drive further comprises a third drive motor for separately driving the third printing form cylinder.

In accordance with an additional feature of the invention, the first transfer cylinder and the first impression cylinder are mechanically coupled with one another.

In accordance with yet another feature of the invention, the printing unit drive further comprises gears arranged on respective drive shafts for the first transfer cylinder and the first impression cylinder and serving as the mechanical couple.

In accordance with yet a further feature of the invention, the first transfer cylinder and the third transfer cylinder are mechanically coupled with one another.

In accordance with yet an added feature of the invention, the printing unit drive further comprises gears arranged on respective drive shafts for the first transfer cylinder and the third transfer cylinder and serving as the mechanical couple.

In accordance with yet an additional feature of the invention, the printing unit drive further comprises a mechanical line shaft connecting the printing units.

In accordance with still another feature of the invention, the line shaft mechanically connects a plurality of printing units in at least one direction selected from the group thereof consisting of horizontal and vertical directions.

In accordance with a further aspect of the invention, there is provided a first printing unit, comprising a first printing form cylinder and a first transfer cylinder, and further comprising a printing unit drive comprising a first drive motor for separately driving the first printing form cylinder, and a line shaft drive motor for jointly driving the first transfer cylinder and a second transfer cylinder of a second printing unit.

In accordance with another feature of the invention, the first printing unit forms part of a web-fed rotary printing machine.

In accordance with an added feature of the invention, the first printing unit further comprises a cylinder arrangement selected from the group consisting of a first impression cylinder, on the one hand, and a third printing form cylinder and a third transfer cylinder, on the other hand.

In accordance with an additional feature of the invention, the first printing form cylinder and the first transfer cylinder are settable off one another and settable on one another.

In accordance with yet another feature of the invention, the third printing form cylinder and the third transfer cylinder are settable off one another and settable on one another.

In accordance with yet a further feature of the invention, the first printing form cylinder and the first transfer cylinder are settable off one another and settable on one another, and the third printing form cylinder and the third transfer cylinder are settable off one another and settable on one another.

In accordance with yet an added feature of the invention, the first printing unit is operatable as an imprinting unit.

In accordance with yet an additional feature of the invention, at least one of the impression cylinders and transfer cylinders is mounted in a cantilever or overhung manner on a side wall of the printing unit and bears a sleeve-like printing blanket which is slidable on and off the respective cylinder.

In accordance with still another aspect of the invention, there is provided a printing machine having at least one printing unit drive comprising a first drive motor for separately driving a first printing form cylinder of a first printing unit, and a line shaft drive motor for jointly driving a first transfer cylinder of the first printing unit and a second transfer cylinder of a second printing unit.

In accordance with an additional feature of the invention, the printing machine is a web-fed rotary printing machine.

In accordance with a concomitant aspect of the invention, there is provided a printing machine having at least one printing unit, comprising a first printing form cylinder and a first transfer cylinder, and further comprising a printing unit drive comprising a first drive motor for separately driving the first printing form cylinder, and a line shaft drive motor for jointly driving the first transfer cylinder and a second transfer cylinder of another printing unit.

Thus, a printing unit drive, in particular for printing units of a web-fed rotary printing machine, wherein a first printing unit comprising a first printing form cylinder and a first transfer cylinder and the printing unit drive comprising a first drive motor for separately driving the first printing form cylinder, is distinguished by the fact that the drive further comprises a line shaft drive motor, which jointly or in-common drives the first transfer cylinder and a second transfer cylinder of a second printing unit.

The printing unit drive according to the invention, having a line shaft drive motor for driving at least two transfer cylinders of two printing units jointly or in common, therefore, advantageously permits one drive motor of a second or further transfer cylinder to be spared when operating a plurality of printing units, as compared with the prior art, due to which procurement, operating, maintenance and repair costs for the motors are able to be reduced. Furthermore, a further advantage results in that the required control and/or regulating electronics can likewise be reduced, because of the lower number of drive motors to be controlled and/or to be regulated and, in this way, costs can likewise be spared and, at the same time, the number of possible sources of failure or error in the control of the drive can be reduced.

In the case of a printing machine of eight-high or eight-cylinder tower construction, three motors can be spared or dispensed with per eight-high tower when the printing unit drive according to the invention is used, because, instead of four joint drive motors, only one joint line shaft drive motor is needed yet for driving the eight blanket cylinders.

Furthermore, provision can be made for the second printing unit to comprise a second printing form cylinder and for the printing unit drive to comprise a second drive motor for separately driving the second printing form cylinder.

This advantageous drive principle makes it possible to operate the two printing units preferably alternatively, i.e., for example, respectively, to run one of the two printing form cylinders on the transfer cylinder assigned thereto in a set-on position, while the other printing form cylinder is run in a set-off position with respect to the transfer cylinder assigned thereto. While the two printing form cylinders, for example, with the respective separate drive motors, are movable between the set-on and the set-off position during operation, wherein it is possible for a flying form change to be carried out, and can be set onto the assigned transfer cylinder again while maintaining register, the two assigned transfer cylinders are driven jointly by a line shaft drive

motor, so that in-register driving of the two transfer cylinders is assured.

In a further embodiment of the invention, provision can be made for the line shaft drive motor also to drive a first impression cylinder of the first printing unit and/or a second impression cylinder of the second printing unit.

Furthermore, however, it is also possible for the first printing unit to comprise a third form cylinder and a third transfer cylinder and for the drive to comprise a third drive motor for separately driving the third form cylinder.

While the drive of impression cylinders can advantageously be used in printing units wherein the material web to be processed is to be printed from only one side, the drive to a further form cylinder and to a further transfer cylinder can advantageously be used in those printing units wherein the material web to be processed is to be printed from both sides. In this regard, it is also possible to carry out a flying form change both on the recto printing side as well as on the verso printing side, and to operate the printing unit cooperatively with a further printing unit as an imprinting unit.

Furthermore, provision can be made for providing the printing unit drive according to the invention with a mechanical coupling between transfer cylinder and impression cylinder. For example, it is possible for the first transfer cylinder and the first impression cylinder to be coupled mechanically, for example, via gears arranged on respective drive shafts of the cylinders.

It is also possible, however, for the first transfer cylinder and the third transfer cylinder to be coupled mechanically, for example, via gears arranged on respective drive shafts of the cylinders.

The mechanical coupling between the two cylinders results in the advantage that the drive via the line shaft drive motor is carried out only on one of the two cylinders, while the other of the two cylinders is driven indirectly from the line shaft drive motor, for example, via one or more gears, chains or toothed belts.

It is furthermore possible and of advantageous effect to equip the printing unit drive with a mechanical line shaft, it being possible for the line shaft to be, for example, a line shaft which mechanically connects a plurality of printing units horizontally or vertically. Thus, the torque from the first line shaft drive motor can advantageously be transmitted via the mechanical line shaft to a plurality of transfer or impression cylinders coupled to the line shaft and therefrom, for example, to further transfer or impression cylinders.

It is a further object of the invention of the instant application to provide a printing unit with which the in-register printing of a material web is made possible, with the number of drive motors being reduced. Furthermore, it is an object of the invention to provide a printing unit which can be operated as an imprinting unit.

A printing unit according to the invention, in particular in a web-fed rotary printing machine which comprises a first printing form cylinder and a first transfer cylinder, is distinguished by a printing unit drive as described hereinabove.

Furthermore, provision can be made for the printing unit to comprise a first impression cylinder, or for the printing unit to comprise a third printing form cylinder and a third transfer cylinder.

In a further refinement of the invention, it is possible for the first printing form cylinder and the first transfer cylinder to be capable of being set off one another and set on one another. In addition, provision can also be made for the third printing form cylinder and the third transfer cylinder to be capable of being set off one another and set on one another.

Due to the adjustability of the printing form cylinders and of the transfer cylinders between various positions, wherein in one position the printing form cylinder is set on the transfer cylinder and in the other position the printing form cylinder is set off the transfer cylinder, with a simultaneous drive to the printing form cylinder with a separate drive motor, it is possible both to set the printing form cylinder on and off in-register and also to operate the printing unit as an imprinting unit.

A printing unit according to the invention can further be distinguished by the fact that at least one of the impression cylinders and/or of the transfer cylinders is mounted in a cantilever or flying manner on a side wall of the printing unit and carries a somewhat sleeve-like printing blanket which can be slid on and pulled off the respective cylinder.

Because the impression and/or transfer cylinders do not have any clamping gaps when blanket sleeves are used, it is advantageously possible to rotate these cylinders somewhat faster than the printing form cylinders, so that the printed image moves slightly on the sleeve after each revolution but without ghosting. In this way, the sleeves wear uniformly and the lifetime thereof is increased. As a result of the separate drive to the respective printing form cylinders, however, the in-register rotation thereof can be assured.

The appertaining inking and dampening units can be driven separately by one or more motors, or can be driven from the form cylinder drive.

Furthermore, a printing machine, in particular a web-fed rotary printing machine or a web-fed rotary offset printing machine, can be distinguished by a printing unit drive as described hereinabove or by a printing unit also as described hereinabove.

Other features which are considered as characteristic for the invention are set forth in the appended claims.

Although the invention is illustrated and described herein as embodied in a printing unit drive, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1a is a diagrammatic side elevational view of a conventional tower configuration of four bridge-type printing units;

FIG. 1b is a view like that of FIG. 1a of a conventional tower configuration of two H-type printing units;

FIG. 1c is a view like those of FIGS. 1a and 1b of a conventional in-line configuration of four upright printing units;

FIG. 2 is a diagrammatic side elevational view of a printing unit drive according to the invention;

FIG. 3 is a diagrammatic side elevational view of printing units according to the invention for engaging in an imprinting unit operation;

FIG. 4a is a diagrammatic side elevational view of two satellite printing units according to the invention;

FIG. 4b is a view like that of FIG. 4a of two semi-satellite printing units according to the invention; and

FIG. 4c is a diagrammatic side elevational view of a Y-type printing unit according to the invention.

### DESCRIPTION OF THE PREFERRED EMBODIMENTS

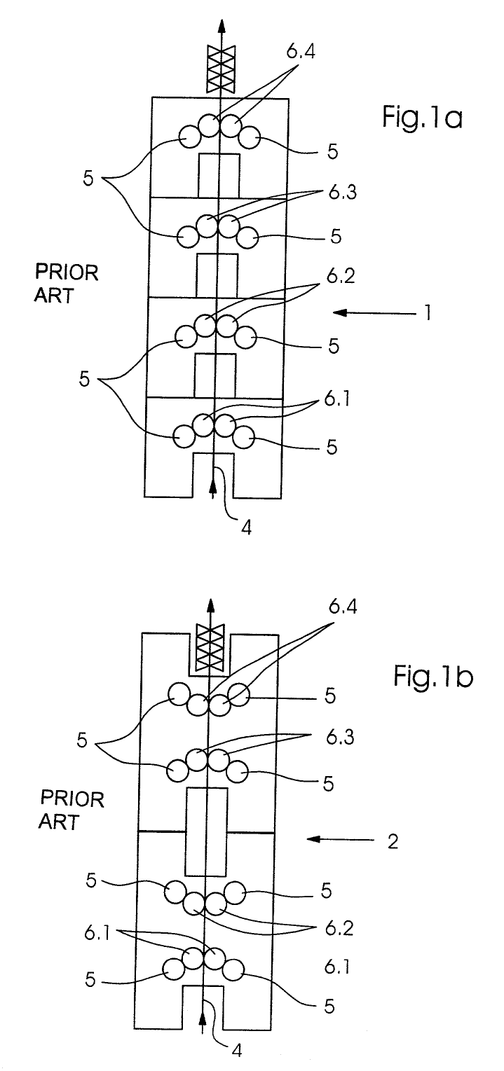

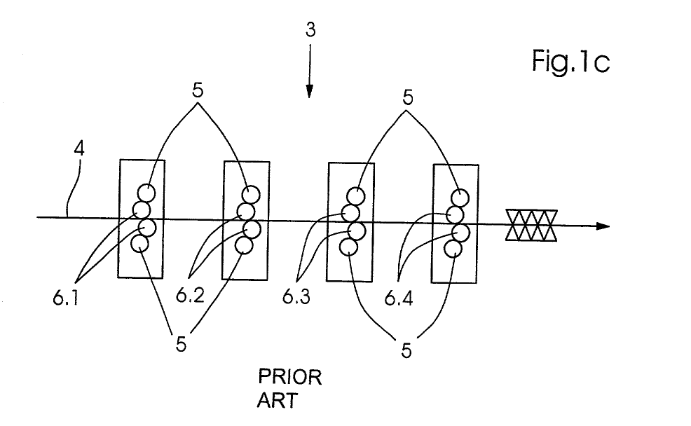

Referring now to the drawings and, first, particularly to FIGS. 1a, 1b and 1c thereof, there are shown therein conventional printing unit arrangements 1, 2 and 3, with which a material web 4 to be printed, for example a paper web, is printed on both sides with four colors, respectively. Should a printing unit drive according to the prior art, for example according to the published German Patent Document DE 198 52 438 A1, be used for each of the printing unit arrangements 1, 2 or 3, respectively, eight individual motors are required to drive the respective printing form or plate cylinders 5 and four further motors, respectively, are required for the respectively joint or common drive of pairs of transfer or blanket cylinders 6.1, 6.2, 6.3 and 6.4.

When the printing unit drive according to the invention is used, a respective common or joint longitudinal shaft motor is required for each of the printing unit arrangements 1, 2 or 3 for driving the transfer or blanket cylinders 6.1, 6.2, 6.3 or 6.4, so that it is possible to dispense with three motors, respectively, and the control and regulating electronics thereof.

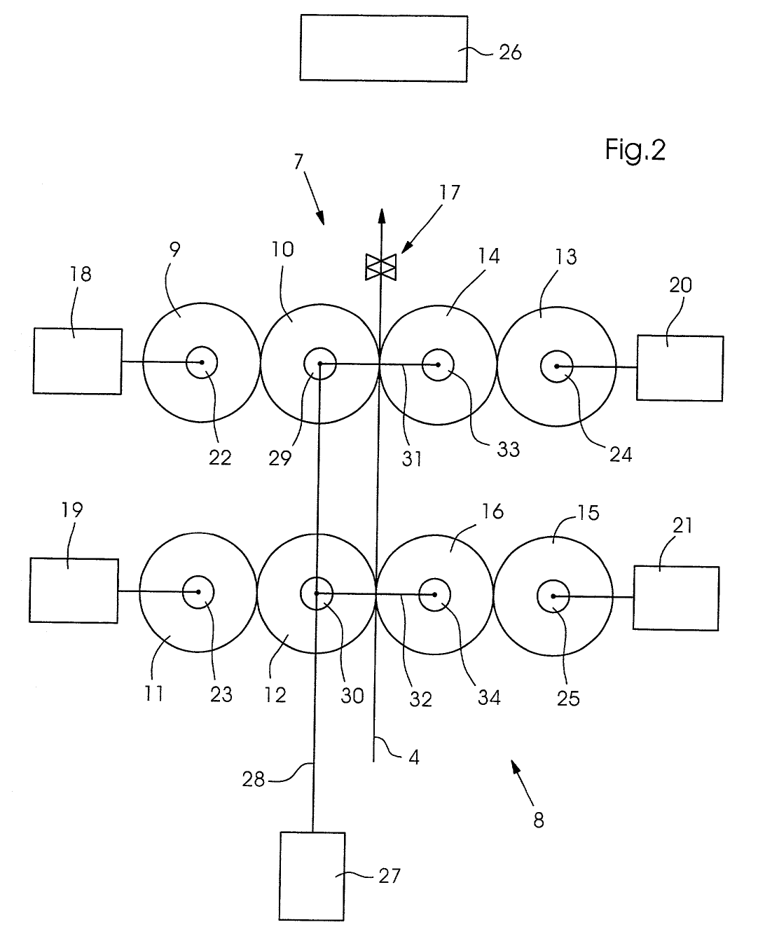

In FIG. 2, there is shown a printing unit drive according to the invention for driving an upper printing unit 7 and a lower printing unit 8, by way of example. Furthermore, further printing units can also be driven with the printing unit drive according to the invention, it being possible for the printing units to be arranged both in a horizontal and in a vertical configuration.

On one side of the material web 4, the upper printing unit 7, as shown in FIG. 2, has a first printing-form cylinder 9 and a first transfer cylinder 10, while the lower printing unit 8 has a second form cylinder 11 and a second transfer cylinder 12. On the other side of the material web 4, the upper printing unit 7 has a third form cylinder 13 and a third transfer cylinder 14, while the lower printing unit 8 has a fourth form cylinder 15 and a fourth transfer cylinder 16. As the material web 4 passes through the two printing units 7 and 8, the material web 4 is printed on both sides thereby in two colors, respectively, as indicated at 17. The four form cylinders 9, 11, 13 and 15 of the two printing units 7 and 8 are driven separately by respective drive motors 18, 19, 20 and 21, the drive motors, as shown in FIG. 2, being couplable, for example, directly with the shaft journals 22, 23, 24 and 25 of the respective form cylinders 9, 11, 13 and 15. However, it is also conceivable to drive the respective form cylinders by the drive motors via gears, for example spur gears, a gear train, one or more drive chains or one or more toothed belts. In addition, provision can be made for connecting the drive motors 18, 19, 20 and 21 directly to the shaft journals 22 to 25 of the printing form cylinders 9, 11, 13 and 15.

For printing in-register on the material web 4, a control and/or regulating device 26 can be provided, which controls and/or regulates the individual motors 18, 19, 20 and 21 via non-illustrated conventional connections. Each individual printing form cylinder 18, 19, 20 or 21 is rotatable continuously or stepwise, i.e., intermittently, in the circumferential direction relative to the continuous or production-printing rotational movement of the transfer cylinder 10, 12, 14 or 16, in or counter to this direction of rotation, in order to set the register or to correct the register during the continuous or producton-printing operation of the printing machine. All four transfer cylinders 10, 12, 14 and 16 are driven by a joint or common drive motor 27, for example, a longitudinal or line shaft drive motor. In this regard, provision can be made, for example, for the drive motor 27 or a plurality of such drive motors to drive a mechanical line shaft 28, which in turn is coupled drivingly to the shaft journals 29 and 30 of the transfer cylinders 10 and 12, respectively, for example, via worm-gear, bevel-gear or spur-gear mechanisms or transmissions. The two transfer cylinders 14 and 16 are coupled drivingly with the driven transfer cylinders 10 and 12 via symbolically illustrated mechanical couplings 31 and 32, respectively. The mechanical coupling between two transfer cylinders, respectively, belonging to a printing unit 10 and 14, on the one hand, and 12 and 16, on the other hand, can be implemented, for example, by non-illustrated intermeshing gears arranged on the shaft journals 29, 30, 33 and 34. Chains or toothed belts, however, can also be provided.

Due to the drive of the four transfer cylinders 10, 12, 14 and 16 by the joint or common drive motor 27, an in-register, slip-free transport of the material web 4 and an in-register, fault-free printing of the material web 4 are ensured.

Furthermore, it is possible for the printing unit 7 to have no third form cylinder 13 and for the cylinder 14 to act merely as an impression cylinder 14 for the first transfer cylinder 10. This is true correspondingly for the printing unit 8.

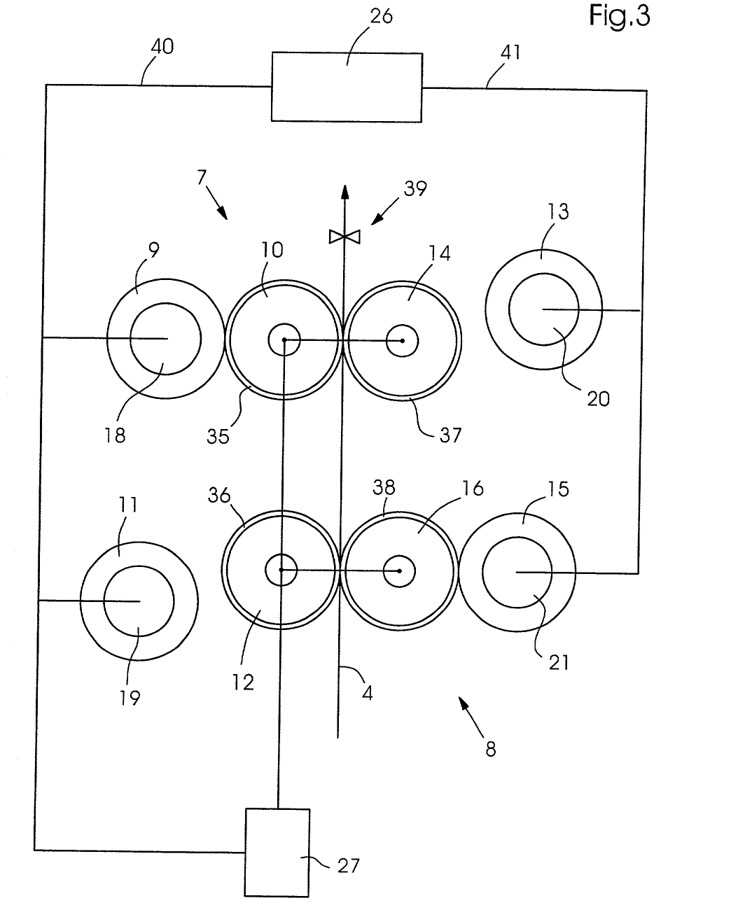

Furthermore, FIG. 3 shows a printing unit according to the invention comprising an upper and a lower printing unit 7, 8, which are provided with a printing unit drive likewise in accordance with the invention. The transfer cylinders 10, 12, 14 and 16 are fitted with blanket sleeves 35, 36, 37 and 38 which are slidable thereon and wihdrawable therefrom, the blanket sleeves 35 to 38, for example, in the case of cantilever-mounted transfer cylinders 10, 12, 14 and 16, being removable axially from the latter. The drive motors 18, 19, 20 and 21 are arranged coaxially with the respective form cylinders 9, 11, 13 and 15 and, with the latter, are movable from a set-on position into a set-off position. It is also possible, however, for only the form cylinders 9, 11, 13 and 15 to be moved between the two positions, and for the respective separate drive motors 18, 19, 20 and 21 not to be moved at the same time, but to remain connected drivingly to the form cylinders assigned thereto.

FIG. 3 shows the first form cylinder 9 and the fourth form cylinder 15 in the set-on position, and the second form cylinder 11 and the third form cylinder 13 in the set-off position with respect to the respective transfer cylinders 10, 12, 14 and 16 assigned thereto. As indicated at 39, the material web 4 is printed by the printing units in one color on both sides thereof, respectively, by the printing units. The control and/or regulating device 26, which is connected via conventional lines or wireless connections 40 and 41 to the separate drive motors 18, 19, 20 and 21 and also to the joint or common drive motor 27, serves for the in-register control of the press cylinders. Furthermore, by the control and/or regulating device 26, the action of setting the individual form cylinders 9, 11, 13 and 15 on and off is controlled, so that the two printing units 7 and 8 can be used jointly as imprinting units. Thus, for example, the set-off form cylinders 11 and 13 can be provided with new printing forms or plates or can have a new image formed thereon.

Of course, it is not necessary for all the printing units to be operated as imprinting units; the printing units illustrated in FIG. 3 show this functionality only by way of example.

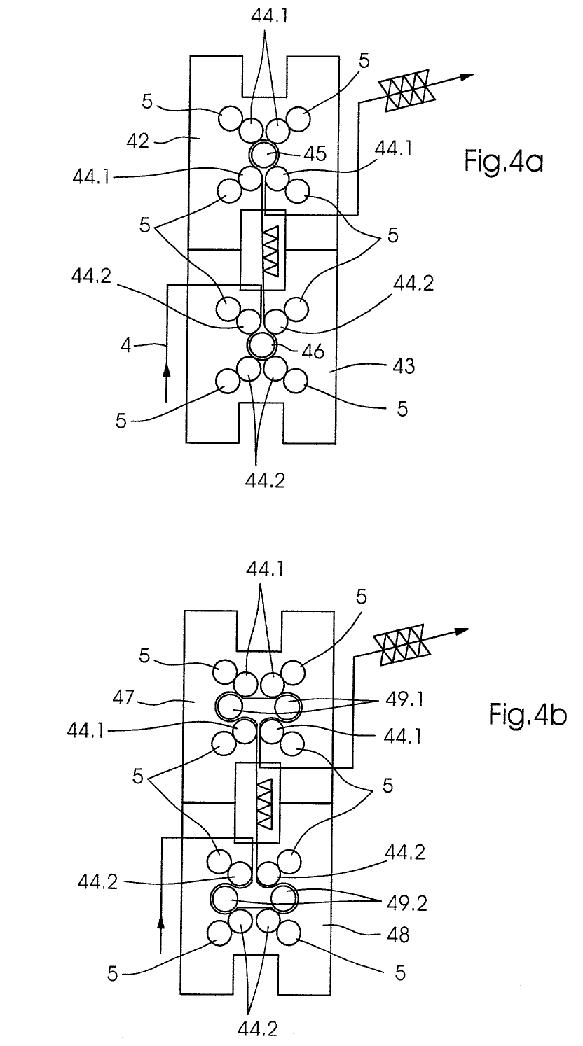

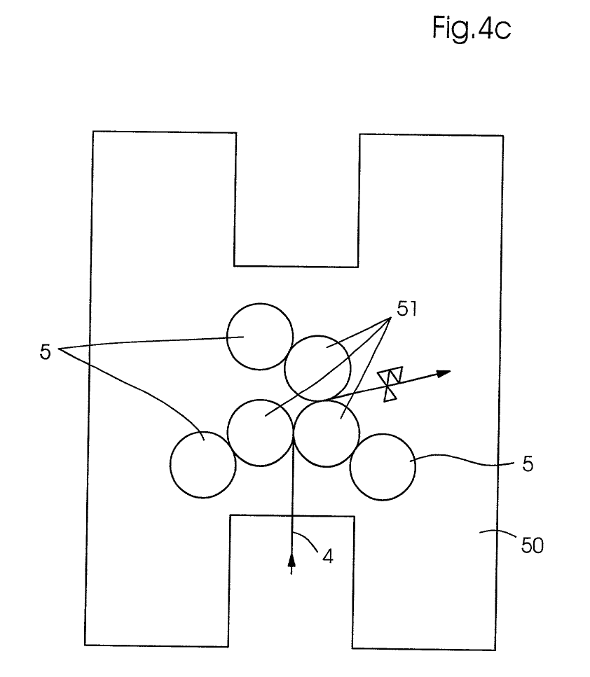

FIGS. 4a, 4b and 4c show further printing unit arrangements which can be provided with a printing unit drive according to the invention. FIG. 4a shows two satellite printing units 42 and 43 which are arranged above one another and print the material web 4 with four colors, respectively, on both sides thereof. With the printing unit drive according to the invention, it is possible to drive the form cylinders 5, respectively, by a separate individual motor, while the transfer cylinders 44.1 and 44.2 and the two satellite cylinders 45 and 46 are driven by a joint or common drive motor, for example, via a line shaft.

In the same manner, the two semi-satellite printing units 47 and 48, also called 10-cylinder printing units, illustrated in FIG. 4b, can be provided with a printing unit drive according to the invention. In this regard, the form cylinders 5, respectively, are drivable by a separate drive motor, while the transfer cylinders 44.1 and 44.2 and the satellite cylinders 49.1 and 49.2 are driven by a joint or common drive motor, for example, via a line shaft.

It is also believed to be apparent from FIG. 4c that a printing unit drive according to the invention can also be used to drive so-called Y-type printing units. The Y-type printing unit 50 has printing form cylinders 5 which are driven by separate drive motors and which interact, from a printing-technology standpoint, with respective transfer cylinders 51, the latter being driven by a joint or common drive motor which is also used additionally for driving further printing units belonging to the printing machine, for example, via a line shaft. As the material web passes through the Y-type printing unit, the web is printed in two colors on one side and in a single color on the other side.

In FIGS. 1a, 1b, 1c, 4a, 4b and 4c, the drive motors are not illustrated in the interest of clarity, because the configuration and arrangement thereof can be readily concluded from FIGS. 2 and 3.

I claim:

1. In a first printing unit having a first printing form cylinder and a first transfer cylinder, a printing unit drive comprising a first drive motor for separately driving the first printing form cylinder, and a line shaft drive motor for jointly driving the first transfer cylinder and a second transfer cylinder of a second printing unit.

2. The printing unit drive according to claim 1, wherein the second printing unit has a second printing form cylinder, and the drive further comprises a second drive motor for separately driving said second printing form cylinder.

3. The printing unit drive according to claim 1, wherein said line shaft drive motor serves for driving at least one of a first impression cylinder of the first printing unit and a second impression cylinder of the second printing unit.

4. The printing unit drive according to claim 1, wherein the first printing unit further has a third printing form cylinder and a third transfer cylinder, and the drive further comprises a third drive motor for separately driving said third printing form cylinder.

5. The printing unit drive according to claim 3, wherein said first transfer cylinder and said first impression cylinder are mechanically coupled with one another.

6. The printing unit drive according to claim 5, further comprising gears arranged on respective drive shafts for said first transfer cylinder and said first impression cylinder and serving as the mechanical couple.

7. The printing unit drive according to claim 4, wherein said first transfer cylinder and said third transfer cylinder are mechanically coupled with one another.

8. The printing unit drive according to claim 7, further comprising gears arranged on respective drive shafts for said first transfer cylinder and said third transfer cylinder and serving as the mechanical couple.

9. The printing unit drive according to claim 1, further comprising a mechanical line shaft connecting the printing units.

10. The printing unit drive according to claim 9, wherein said line shaft mechanically connects a plurality of printing units in at least one direction selected from the group thereof consisting of horizontal and vertical directions.

11. A first printing unit, comprising a first printing form cylinder and a first transfer cylinder, and further comprising a printing unit drive comprising a first drive motor for separately driving said first printing form cylinder, and a line shaft drive motor for jointly driving said first transfer cylinder and a second transfer cylinder of a second printing unit.

12. A first printing unit according to claim 11, wherein the first printing unit forms part of a web-fed rotary printing machine.

13. The first printing unit according to claim 11, further comprising a cylinder arrangement selected from the group consisting of a first impression cylinder, on the one hand, and a third printing form cylinder and a third transfer cylinder, on the other hand.

14. The first printing unit according to claim 11, wherein said first printing form cylinder and said first transfer cylinder are settable off one another and settable on one another.

15. The first printing unit according to claim 11, wherein said third printing form cylinder and said third transfer cylinder are settable off one another and settable on one another.

16. The first printing unit according to claim 11, wherein said first printing form cylinder and said first transfer cylinder are settable off one another and settable on one another, and said third printing form cylinder and said third transfer cylinder are settable off one another and settable on one another.

17. The first printing unit according to claim 11, wherein the first printing unit is operatable as an imprinting unit.

18. The printing unit according to claim 4, wherein at least one of said impression cylinders and transfer cylinders is mounted in a cantilever or overhung manner on a side wall of the printing unit and bears a sleeve-like printing blanket which is slidable on and off the respective cylinder.

19. A printing machine having at least one printing unit drive comprising a first drive motor for separately driving a first printing form cylinder of a first printing unit, and a line shaft drive motor for jointly driving a first transfer cylinder of the first printing unit and a second transfer cylinder of a second printing unit.

20. The printing machine according to claim 19, being a web-fed rotary printing machine.

21. A printing machine having at least one printing unit, comprising a first printing form cylinder and a first transfer cylinder, and further comprising a printing unit drive comprising a first drive motor for separately driving said first printing form cylinder, and a line shaft drive motor for jointly driving said first transfer cylinder and a second transfer cylinder of another printing unit.
